(19) United States
(12) Patent Application Publication
(10) Pub. No.: US 2013/0197122 A1
(43) Pub. Date: Aug. 1, 2013

(54) NANOCOMPOSITES WITH IMPROVED HOMOGENEITY

(71) Applicants: Séverine Gauchet, La Riche (FR); Jacques Michel, Feluy (BE); Olivier Lhost, Havre (BD); Pascal Navez, Fontaine I'Eveque (BE); Jacques Everaert, Delmar, NY (US); Romain Luijkx, Chercq (BE); Marc Dupire, Hyon (BE)

(72) Inventors: Séverine Gauchet, La Riche (FR); Jacques Michel, Feluy (BE); Olivier Lhost, Havre (BD); Pascal Navez, Fontaine I'Eveque (BE); Jacques Everaert, Delmar, NY (US); Romain Luijkx, Chercq (BE); Marc Dupire, Hyon (BE)

(73) Assignee: TOTAL PETROCHEMICALS RESEARCH FELUY, Seneffe (feluy) (BE)

(21) Appl. No.: 13/579,730

(22) PCT Filed: Mar. 2, 2011
(86) PCT No.: PCT/EP2011/053065

§ 371 Date: Oct. 15, 2012

(30) Foreign Application Priority Data
Mar. 2, 2010 (EP) 10155175.2

(51) Int. Cl. C08K 3/04; C08K 5/07

(52) U.S. Cl. CPC C08K 3/04; C08K 5/07; B82Y 30/00
USPC 522/157; 524/495; 522/183; 106/476; 977/752

(57) ABSTRACT

The present invention relates to nanocomposites comprising nanoparticles and a thermoplastic polymer composition, said nanocomposite being characterized by improved homogeneity, and in consequence by improved properties. Further, the present invention relates to a process for the production of such nanocomposites by first dispersing the nanoparticles in a dispersant and subsequent blending with a thermoplastic polymer composition.

### FIELD OF THE INVENTION

The present invention relates to nanocomposites comprising nanoparticles and a thermoplastic polymer composition, said nanocomposites being characterized by improved homogeneity, and in consequence by improved properties. Further, the present invention relates to a process for the production of such nanocomposites by first dispersing the nanoparticles in a dispersant and subsequently blending with a thermoplastic polymer composition.

### THE TECHNICAL PROBLEM AND THE PRIOR ART

Nanoparticles can be generally characterized by having a size between 1 nm and 500 nm. In the case of, for example, nanotubes this definition of size can be limited to two dimensions only, i.e. the third dimension may be outside of these limits. The small size of nanoparticles results in a high ratio of surface area to volume, also referred to as the aspect ratio. In consequence the percentage of atoms present on the surface gains in importance with respect to the percentage of atoms in the bulk. Hence nanoparticles offer interesting and frequently unexpected properties because their properties are rather the result of the surface of the particles than of the bulk volume. For example, nanoparticles have shown surprising mechanical, optical and electrical properties, even at low concentrations.

The surprising properties of nanoparticles have also attracted interest in polymer science. Particular attention has been focused on carbon nanotubes (CNTs). It has long been known that the addition of fibers into polymers can significantly improve the mechanical properties of the polymers. Long fibers made of materials such as metal, glass or asbestos have been used to this effect (see for example GB 1179569 A). Boron, silicon carbide and even carbon fibers have also been developed for this purpose. The initially developed carbon fibers had diameters of several tens of microns and lengths on the order of millimeters. They were quite light and despite this had impressive mechanical properties, displaying Young's moduli in the range of 230 to 725 GPa and strengths in the range of 1.5 to 4.8 GPa. Carbon nanofibers, having higher aspect ratios, have also been prepared with even smaller diameters of about 100 nm and lengths up to 100 microns, Young's moduli in the range of 100 to 1000 GPa and strengths in the range of 2.5 to 3.5 GPa.

Carbon nanotubes are structurally related to Buckminster fullerene (C₆₀). Carbon nanotubes have diameters in the range from 1 nm to 100 nm and lengths of up to several millimeters, thus giving them a potentially very high length to diameter ratio. Carbon nanotubes can be single-walled or multi-walled. A single-walled carbon nanotube (SWNT) is a one-atom thick sheet of graphite (called graphene) rolled up into a seamless hollow cylinder, which can have a diameter on the order of 1 nm and lengths of up to several millimeters. The aspect ratio can thus potentially reach values of several millions. Multi-walled carbon nanotubes (MWNT) have also been developed. They are concentric arrays of single-walled carbon nanotubes (also known as the Russian doll model).

With Young moduli of up to 5 TPa and mechanical strengths even greater than 70 GPa, carbon nanotubes have great potential to replace conventional carbon fibers as polymer reinforcements.

Carbon nanotubes are also extremely light and have unique thermal and electronic properties. Depending on how the graphene sheet is rolled i.e. the relationship between the axial direction and the unit vectors describing the hexagonal lattice, and depending on the diameter, on the number of walls and on the helicity, the nanotube can be designed to be conducting or semi-conducting.

The properties of carbon nanotubes are also influenced by their purity. High purity carbon nanotubes have been found to be extremely conductive. In theory, pristine carbon nanotubes should be able to have an electrical current density of more than 1,000 times greater than metals such as silver and copper. Nanotubes may thus be added to an electrically insulating polymer to result in conductive plastics having exceedingly low percolation thresholds as described for example in WO 97/15934.

As for thermal properties, carbon nanotubes are also very conductive for phonons. Calculations predict that at room temperature, thermal conductivity of up to 6000 W/m K can be achieved with pure nanotubes, which is roughly twice as much as for pure diamond. Nanotubes in a polymer matrix can thus provide thermally conductive resin compositions.

Carbon nanotubes have been cited as having flame retardant properties. Nanotubes in a polymer matrix could therefore provide materials with fire proof properties.

In recent years substantive efforts have been made to utilize the properties of nanoparticles, particularly of carbon nanotubes, in improving the mechanical properties of polymers (polymer reinforcement). It has been found that probably the most important factor in polymer reinforcement is the nanoparticles' distribution in the polymer (J. N. Coleman et al., Carbon 44 (2006) 1624-1652). It is believed that the nanoparticles, and in particular the carbon nanotubes, must be uniformly distributed in the polymer and each nanoparticle individually coated with the polymer so that an efficient load transfer to the nanoparticles can be achieved. Lack of homogeneity, i.e. uneven distribution of the nanoparticles, will create weak spots and an uneven distribution of stress, in consequence leading at best to only marginal increases in mechanical properties. The same line of reasoning applies to electrical conductivity.

Due to difficulties in dispersion the hopes of drastically improving the polymers' mechanical properties by the incorporation of nanoparticles have not yet been fulfilled. Hence, the need to improve the distribution of nanoparticles in polymers remains.

It is therefore an object of the present invention to provide a nanocomposite with an improved homogeneity, i.e. improved distribution of nanoparticles.

It is also an object of the present invention to provide a nanocomposite having improved processability in transformation processes, such as for example in molding or extrusion processes.

Furthermore, it an object of the present invention to provide a nanocomposite having improved properties, for example mechanical properties or electrical properties.

It is also an object of the present invention to provide a process for the production of such a nanocomposite fulfilling the above objectives.

In addition it is an object of the present invention to provide a more stable nanoparticles dispersion.

### BRIEF DESCRIPTION OF THE INVENTION

We have now discovered that these objectives can be met either individually or in any combination by the present nanocomposite and the process for their production.

Accordingly, the present invention provides a nanocomposite comprising a thermoplastic polymer composition and at least 0.001% by weight, relative to the total weight of nanocomposite, of nanoparticles, characterized in that isolated nanoparticles are present.

Further, the present invention provides articles comprising the above composition.

Accordingly, the present invention also provides a process for producing said nanocomposite having improved homogeneity, said process comprising the steps of
(a) dispersing nanoparticles in a dispersant to produce a nanoparticles dispersion,
(b) combining the nanoparticles dispersion obtained in step (a) with a thermoplastic polymer composition, and
(c) subsequently removing the dispersant to obtain the nanocomposite,
   wherein the dispersant is polar.

Alternatively, the present invention provides a process for producing said nanocomposite having improved homogeneity, said process comprising the steps of
(a) dispersing nanoparticles in a dispersant to produce a nanoparticles dispersion,
(b′) removing either in part or completely the dispersant from the nanoparticles dispersion obtained in step (a) by lyophilization to obtain lyophilized nanoparticles, and
(c′) combining the lyophilized nanoparticles obtained in step (b′) with a thermoplastic polymer composition,
   wherein the dispersant is polar.

Furthermore, the present invention provides a dispersion comprising nanoparticles and a dispersant, wherein the dispersant is selected from the group consisting of liquid carbon dioxide, water, a liquid polar organic compound or a blend of these, wherein the liquid polar organic compound is one that is liquid under standard conditions, i.e. at a temperature of 25° C. and a pressure of 1 atm.

### DETAILED DESCRIPTION OF THE INVENTION

In the context of the present invention the terms “olefin polymer” and “polyolefin” are used interchangeably. Equally, the terms “propylene polymer” and “polypropylene” as well as the terms “ethylene polymer” and “polyethylene” are used interchangeably.

In the context of the present invention the term “nanocomposite” is used to denote a blend of nanoparticles and one or more thermoplastic polymers.

Upon dispersing nanoparticles in a suitable dispersant the applicant noted that the resulting dispersion was characterized by much longer sedimentation time than a conventional dispersion known from the literature. It was also observed that blending of the nanoparticles dispersion with a thermoplastic polymer composition to obtain a nanocomposite led to more homogeneous distribution of the nanoparticles, said nanocomposite showing surprising benefits in terms of mechanical properties and in terms of processability.

The nanocomposite of the present invention comprises a thermoplastic polymer composition and at least 0.001% by weight, relative to the total weight of the nanocomposite, of nanoparticles, characterized in that isolated nanoparticles are present. Preferably, the nanocomposite of the present invention consists of a thermoplastic polymer composition and at least 0.001% by weight, relative to the total weight of the nanocomposite, of nanoparticles. It is to be understood that the weight percentages of all components of the nanocomposite adds up to 100%.

Preferably, the nanocomposite of the present invention comprises at least 0.005% by weight, more preferably at least 0.01% by weight and most preferably at least 0.05% by weight, relative to the total weight of the nanocomposite, of nanoparticles.

Preferably, the nanocomposite of the present invention comprises at most 20% by weight, more preferably at most 15% by weight, even more preferably at most 10% by weight, and most preferably at most 5.0% by weight, relative to the total weight of the nanocomposite, of nanoparticles.

Preferably at least 1.0% by weight, more preferably at least 2.0% by weight, and most preferably at least 5.0% by weight of the total amount of nanoparticles is present as isolated nanoparticles.

In the context of the present invention the term “isolated nanoparticles” is used to denote non-agglomerated nanoparticles; in the case of elongated nanoparticles, e.g. nanotubes or nanofibers, the term is meant to denote that two elongated nanoparticles have an intersection that has a length of at most two times the diameter of the elongated nanoparticle with the bigger diameter.

### Thermoplastic Polymer Composition

The thermoplastic polymer compositions suitable for use in the present invention are not particularly limited. However, It is preferred that the thermoplastic polymer composition comprises at least 50 wt %, more preferably at least 70 wt % or 90 wt %, even more preferably at least 95 wt % or 97 wt %, still even more preferably at least 99.0 wt % or 99.5 wt % or 99.9 wt %, relative to its total weight, of a polymer selected from the group consisting of polyamides, polyolefins, poly(hydroxy carboxylic acid), polystyrene, polyesters or blends of these. Most preferably, the thermoplastic polymer composition consists of a polymer selected from the group consisting of polyamides, polyolefins, poly(hydroxy carboxylic acid), polystyrene, polyesters or blends of these. The most preferred polymers are polyolefins.

The polymers used in the present invention may comprise conventional additives, such as for example antioxidants, light stabilizers, acid scavengers, lubricants, antistatic additives, nucleating/clarifying agents, colorants. An overview of such additives may be found in Plastics Additives Handbook, ed. H. Zweifel, 5^{th} edition, 2001, Hanser Publishers.

The polymers used in the present invention can be produced by any method known in the art. Their production therefore is well known to the person skilled in the art and need not be described further.

Polyolefins

The polyolefins used in the present invention may be any olefin homopolymer or any copolymer of an olefin and one or more comonomers. The polyolefins may be atactic, syndiotactic or isotactic. The olefin can for example be ethylene, propylene, 1-butene, 1-pentene, 1-hexene, 4-methyl-1-pentene or 1-octene, but also cycloolefins such as for example cyclopentene, cyclohexene, cyclooctene or norbornene. The comonomer is different from the olefin and chosen such that it is suited for copolymerization with the olefin. The comonomer may also be an olefin as defined above. Further examples of suitable comonomers are vinyl acetate (H₃C—C(═O)O—CH═CH₂) or vinyl alcohol (“HO—CH═CH₂”, which as such is not stable and tends to polymerize). Examples of olefin copolymers suited for use in the present invention are random copolymers of propylene and ethylene, random copolymers of propylene and 1-butene, heterophasic copolymers of propylene and ethylene, ethylene-butene copolymers, ethylene-hexene copolymers, ethylene-octene copolymers, copolymers of ethylene and vinyl acetate (EVA), copolymers of ethylene and vinyl alcohol (EVOH).

Preferred polyolefins for use in the present invention are propylene and ethylene polymers.

Most preferred polyolefins for use in the present invention are olefin homopolymers and copolymers of an olefin and one or more comonomers, wherein said olefin and said one or more comonomer are different, and wherein said olefin is ethylene or propylene, and wherein said one of more comonomer is selected from the group consisting of ethylene, propylene, 1-butene, 1-pentene, 1-hexene, 4-methyl-1-pentene or 1-octene. Such olefin homopolymer and copolymers of an olefin and one or more comonomers are non-polar polymers.

Polyamides

Polyamides are characterized in that the polymer chain comprises amide groups (—NH—C(═O)—). Polyamides useful in the present invention are preferably characterized by one of the following two chemical structures

[—NH—(CH₂)ₙ—C(═O)—]ₓ

[—NH—(CH₂)ₘ—NH—C(═O)—(CH₂)ₙ—C(═O)—]ₓ

wherein m and n may be independently chosen from one another and be an integer from 1 to 20.

Specific examples of suitable polyamides are polyamides 4, 6, 7, 8, 9, 10, 11, 12, 46, 66, 610, 612 and 613.

Polystyrenes

The polystyrenes used in the present invention may be any styrene homopolymer or copolymer. They may be atactic, syndiotactic or isotactic. Styrene copolymers comprise one or more suitable comonomers, i.e. polymerizable compounds different from styrene. Examples of suitable comonomers are butadiene, acrylonitrile, acrylic acid or methacrylic acid. Examples of styrene copolymers that may be used in the present invention are butadiene-styrene copolymers, which are also referred to as high-impact polystyrene (HIPS), acrylonitrile-butadiene-styrene copolymers (ABS) or styrene-acrylonitrile copolymers (SAN).

Polyesters

Polyesters that may be used in the present invention are preferably characterized by the following chemical structure

[—C(═O)—C₆H₄—C(═O)O—(CH₂—CH₂)ₙ—O—]ₓ

wherein n is an integer from 1 to 10, with preferred values being 1 or 2.

Specific examples of suitable polyesters are polyethylene terephthalate (PET) and polybutylene terephthalate (PBT).

Furthermore, preferred polyesters are poly(hydroxy carboxylic acid)s as described below.

The poly(hydroxy carboxylic acid)s used in the present invention can be any polymer wherein the monomers comprise at least one hydroxyl group and at least carboxyl group. The hydroxy carboxylic acid monomer is preferably obtained from renewable resources such as corn and rice or other sugar- or starch-producing plants. Preferably the poly(hydroxy carboxylic acid) used according to the invention is biodegradable. The term “poly(hydroxy carboxylic acid)” includes homo- and co-polymers herein.

The poly(hydroxy carboxylic acid) can be represented as in Formula I:

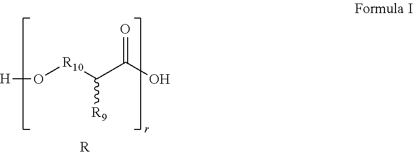

wherein R9 is hydrogen or a branched or linear alkyl comprising from 1 to 12 carbon atoms; R10 is optional and can be a branched, cyclic or linear alkylene chains comprising from 1 to 12 carbon atoms; and “r” represents the number of repeating units of R and is any integer from 30 to 15000.

The monomeric repeating unit is not particularly limited, as long as it is aliphatic and has a hydroxyl residue and a carboxyl residue. Examples of possible monomers include lactic acid, glycolic acid, 3-hydroxybutyric acid, 4-hydroxybutyric acid, 4-hydroxyvaleric acid, 5-hydroxyvaleric acid, 6-hydroxycaproic acid and the like.

The monomeric repeating unit may also be derived from a cyclic monomer or cyclic dimer of the respective aliphatic hydroxycarboxylic acid. Examples of these include lactide, glycolide, β-propiolactone, β-butyrolactone, γ-butyrolactone, γ-valerolactone, δ-valerolactone, ε-caprolactone and the like.

In the case of asymmetric carbon atoms within the hydroxy carboxylic acid unit, each of the D-form and the L-form as well as mixtures of both may be used. Racemic mixtures can also be used.

The term “poly(hydroxy carboxylic acid)” also includes blends of more than one poly(hydroxy carboxylic acid).

The poly(hydroxy carboxylic acid) may optionally comprise one or more comonomers.

The comonomer can be a second different hydroxycarboxylic acid as defined above in Formula I. The weight percentage of each hydroxycarboxylic acid is not particularly limited.

The comonomer can also comprise dibasic carboxylic acids and dihydric alcohols. These react together to form aliphatic esters, oligoesters or polyesters as shown in Formula II having a free hydroxyl end group and a free carboxylic acid end group, capable of reacting with hydroxy carboxylic acids, such as lactic acid and polymers thereof.

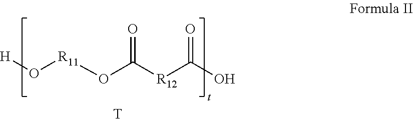

wherein R11 and R12 are branched or linear alkylenes comprising from 1 to 12 carbon atoms and can be the same or different; “t” represents the number of repeating units T.

For these copolymers the sum of the number of repeating units “r” (Formula I) and “t” (Formula II) is any integer from 30 to 15000. The weight percentages of each monomer i.e. the hydroxycarboxylic acid monomer and the aliphatic ester or polyester comonomer of Formula II are not particularly limited. Preferably, the poly(hydroxy carboxylic acid) comprises at least 50 wt % of hydroxycarboxylic acid monomers and at most 50 wt % of aliphatic ester, oligoester or polyester comonomers.

The dihydric alcohols and the dibasic acids that can be used in the aliphatic polyester unit as shown in Formula II are not particularly limited. Examples of possible dihydric alcohols include ethylene glycol, diethylene glycol, triethyleneglycol, propylene glycol, dipropylene glycol, 1,3-butanediol, 1,4-butanediol, 3-methyl-1,5-pentanediol, 1,6-hexanediol, 1,7-octanediol, 1,9-nonanediol, neopentyl glycol, 1,4-cyclohexanediol, isosorbide and 1,4-cyclohexane dimethanol and mixtures thereof.

Aliphatic dibasic acids include succinic acid, oxalic acid, malonic acid, glutaric acid, adipic acid, pimelic acid, suberic acid, azelaic acid, sebacic acid; undecanoic diacid, dodecanic diacid and 3,3-dimethylpentanoic diacid, cyclic dicarboxylic acids such as cyclohexanedicarboxylic acid and mixtures thereof. The dibasic acid residue in the hydroxy carboxylic acid copolymer can also be derived from the equivalent diacylchlorides or diesters of the aliphatic dibasic acids.

In the case of asymmetric carbon atoms within the dihydric alcohol or the dibasic acid, each of the D-form and the L-form as well as mixtures of both may be used. Racemic mixtures can also be used.

The copolymer can be an alternating, periodic, random, statistical or block copolymer.

Polymerization can be carried out according to any method known in the art for polymerizing hydroxy carboxylic acids. Polymerization of hydroxy carboxylic acids and their cyclic dimmers is carried out by polycondensation or ring-opening polymerization. Copolymerization of hydroxycarboxylic acids can be carried out according to any method known in the art. The hydroxycarboxylic acid can be polymerized separately prior to copolymerization with the comonomer or both can be polymerized simultaneously.

In general, the poly(hydroxy carboxylic acid), homo- or copolymer (copolymerized with a second different hydroxy carboxylic acid or with an aliphatic ester or polyester as described above), may also comprise branching agents. These poly(hydroxy carboxylic acid)s can have a branched, star or three-dimensional network structure. The branching agent is not limited so long as it comprises at least three hydroxyl groups and/or at least three carboxyl groups. The branching agent can be added during polymerization. Examples include polymers such as polysaccharides, in particular cellulose, starch, amylopectin, dextrin, dextran, glycogen, pectin, chitin, chitosan and derivates thereof. Other examples include aliphatic polyhydric alcohols such as glycerine, pentaerythritol, dipentaerythritol, trimethylolethane, trimethylolpropane, xylitol, inositol and the like. Yet another example of a branching agent is an aliphatic polybasic acid. Such acids include cyclohexanehexacarboxylic acid, butane-1,2,3,4-tetracarboxylic acid, 1,3,5-pentane-tricarboxylic acid, 1,1,2-ethanetricarboxylic acid and the like.

The total molecular weight of the poly(hydroxy carboxylic acid) depends on the desired mechanical and thermal properties and moldability of the nanotube composite and of the final resin composition. It is preferably from 5,000 to 1,000,000 g/mol, more preferably from 10,000 to 500,000 g/mol and even more preferably from 35,000 to 200,000 g/mol. Most preferably the total molecular weight of the polymer is from 40,000 to 100,000 g/mol.

The molecular weight distribution is generally monomodal. However, in the case of mixtures of two or more fractions of poly(hydroxy carboxylic acid)s of different weight average molecular weight and/or of different type, the molecular weight distribution can also be multimodal e.g. bi- or trimodal.

From a standpoint of availability and transparency, the poly(hydroxy carboxylic acid) is preferably a polylactic acid (PLA). Preferably the polylactic acid is a homopolymer obtained either directly from lactic acid or from lactide, preferably from lactide.

### Nanoparticles

The nanoparticles used in the present invention can generally be characterized by having a size between 1 nm and 500 nm. In the case of, for example, nanotubes this definition of size can be limited to two dimensions only, i.e. the third dimension may be outside of these limits. Preferably, the nanoparticles are selected from the group consisting of nanotubes, nanofibers, carbon black and blends of these. More preferred are nanotubes, nanofibers, carbon black and blends of these. Even more preferred are nanotubes, nanofibers and blends of these. Most preferred are nanotubes. Amongst the nanotubes, carbon nanotubes are particularly preferred.

Nanotubes

Nanotubes are cylindrical in shape and structurally related to fullerenes, an example of which is Buckminster fullerene (C₆₀). Nanotubes may be open or capped at their ends. The end cap may for example be a Buckminster-type fullerene hemisphere. The nanotubes made in the present invention may be made from carbon or from a combination of elements of groups 13 and 15 of the periodic table of the elements (see International Union of Pure and Applied Chemistry (IUPAC) Periodic Table of the Elements, version dated Jun. 22, 2007), such as for example a combination of boron or aluminium with nitrogen or phosphorus. Nanotubes may also be made from carbon and a combination of elements of groups 13 and 15 of the periodic table of the elements. Preferably the nanotubes used in the present invention are made from carbon, i.e. they comprise more than 90%, more preferably more than 95%, even more preferably more than 99% and most preferably more than 99.9% of their total weight in carbon; such nanotubes are generally referred to as “carbon nanotubes”. However, minor amounts of other atoms may also be present. Preferably, the outer diameter of the nanotubes is in the range from 0.5 nm to 100 nm. Their length is preferably in the range from 50 nm to 50 mm.

Nanotubes exist as single-walled nanotubes (SWNT) and multi-walled nanotubes (MWNT), i.e. nanotubes having one single wall and nanotubes having more than one wall. In single-walled nanotubes a one atom thick sheet of atoms, for example a one atom thick sheet of graphite (also called graphene), is rolled seamlessly to form a cylinder. Multi-walled nanotubes consist of a number of such cylinders arranged concentrically. The arrangement in a multi-walled nanotube can be described by the so-called Russian doll model, wherein a larger doll opens to reveal a smaller doll.

Nanotubes, irrespectively of whether they are single-walled or multi-walled, may be characterized by their outer diameter or by their length or by both. Outer length and diameter are as defined in the following.

Single-walled nanotubes are preferably characterized by an outer diameter of at least 0.5 nm, more preferably of at least 1.0 nm, and most preferably of at least 2.0 nm. Preferably their outer diameter is at most 50 nm, more preferably at most 30 nm and most preferably at most 10 nm.

Preferably, the length of single-walled nanotubes is at least 0.1 μm, more preferably at least 1.0 μm, even more preferably at least 10 μm and most preferably at least 100 μm. Preferably, their length is at most 50 mm, more preferably at most 25 mm, and most preferably at most 10 mm.

Multi-walled nanotubes are preferably characterized by an outer diameter of at least 1.0 nm, more preferably of at least 2.0 nm, 4.0 nm, 6.0 nm or 8.0 nm, and most preferably of at least 10.0 nm. The preferred outer diameter is at most 100 nm, more preferably at most 80 nm, 60 nm or 40 nm, and most preferably at most 20 nm. Most preferably, the outer diameter is in the range from 10.0 nm to 20 nm.

The preferred length of the multi-walled nanotubes is at least 50 nm, more preferably at least 75 nm, and most preferably at least 100 nm. Their preferred length is at most 20 mm, more preferably at most 10 mm, 500 μm, 250 μm, 100 μm, 75 μm, 50 μm, 40 μm, 30 μm or 20 μm, and most preferably at most 10 μm. The most preferred length is in the range from 100 nm to 10 μm.

The carbon nanotubes used in the present invention can be produced by any method known in the art. They can be produced by the catalyst decomposition of hydrocarbons, a technique that is called Catalytic Carbon Vapor Deposition (CCVD). This method produces both SWNT and MWNT: the by-products are soot and encapsulated metal(s) nanoparticles. Other methods for producing carbon nanotubes include the arc-discharge method, the plasma decomposition of hydrocarbons or the pyrolysis of selected polymer under selected oxidative conditions. The starting hydrocarbons can be acetylene, ethylene, butane, propane, ethane, methane or any other gaseous or volatile carbon-containing compound. The catalyst, if present, is used in either pure or in supported form. The presence of a support greatly improves the selectivity of the catalysts but it contaminates the carbon nanotubes with support particles, in addition to the soot and amorphous carbon produced during pyrolysis. Purification can remove these by-products and impurities. This can be carried out according to the following two steps:
1) the dissolution of the support particles, typically carried out with an appropriate agent that depends upon the nature of the support and
2) the removal of the pyrolytic carbon component, typically based on either oxidation or reduction processes.

The term “carbon nanotubes” also includes the use of “functionalized” carbon nanotubes, as well as non-functionalized carbon nanotubes. The surface composition of the nanotubes can be modified in order to improve their distribution in the polymer matrix and their linking properties; “functionalizing” nanotubes is described for example in J. Chen et al., Science, 282, 95-98, 1998; Y. Chen et al., J. Mater. Res., 13, 2423-2431, 1998; M. A. Haman et al., Adv. Mater., 11, 834-840, 1999; A. Hiroki et al., J. Phys. Chem. B, 103, 8116-8121, 1999. The functionalization can be carried out by reacting the carbon nanotubes, for example, with an alkylamine. It results in a better separation of the nanotubes in the polymer matrix thereby facilitating uniform distribution within the polymer matrix. If the functionalization is carried out on both the nanotubes and the polymer, it promotes their covalent bonding and miscibility, thereby improving the electrical and mechanical properties of the filled compound.

However, in the context of the present invention non-functionalized carbon nanotubes are preferred.

An example of commercially available multi-walled carbon nanotubes is Graphistrength™ 100, available from Arkema.

Nanofibers

The nanofibers used in the present invention preferably have a diameter of at least 1 nm, more preferably of at least 2 nm and most preferably of at least 5 nm. Preferably, their diameter is at most 500 nm, more preferably at most 300 nm, and most preferably at most 100 nm. Their length may vary from 10 μm to several centimeters.

Preferably, the nanofibers used in the present invention are carbon nanofibers, i.e. they comprise at least 50 wt %, relative to the total weight of the nanofiber, of carbon. Preferably, the nanofibers used in the present invention comprise polyolefins, polyamides, polystyrenes, polyesters, all of which are as defined previously in the present invention, as well as polyurethanes, polycarbonates, polyacrylonitrile, polyvinyl alcohol, polymethacrylate, polyethylene oxide, polyvinylchloride, or any blend thereof.

The nanofibers used in the present invention can be produced by any suitable method, such as for example by drawing of a melt-spun or solution-spun fiber, by template synthesis, phase separation, self-assembly, electrospinning of a polymer solution or electrospinning of a polymer melt. Further information, particularly on electrospinning, can be found in Huang et al., “A review on polymer nanofibers by electrospinning and their applications in nanocomposites”, Composites Science and Technology 63 (2003) 2223-2253.

Carbon Black

Carbon black is made of microcrystalline, finely dispersed carbon particles, which are obtained through incomplete combustion or thermal decomposition of liquid or gaseous hydrocarbons. Carbon black particles are characterized by a diameter in the range of from 5 nm to 500 nm, though they have a great tendency to form agglomerates. Carbon black comprises from 96 wt % to 99 wt % of carbon, relative to its total weight, with the remainder being hydrogen, nitrogen, oxygen, sulfur or any combination of these. The surface properties of carbon black are dominated by oxygen-comprising functional groups, such as hydroxyl, carboxyl or carbonyl groups, located on its surface.

### Process for Producing Nanocomposites

The present invention provides a process for the production of the previously defined nanocomposite having improved distribution of the nanoparticles, said process comprising the step of dispersing the nanoparticles in a dispersant to produce a nanoparticles dispersion.

More particularly, the present invention provides a process for producing the previously defined nanocomposite having improved homogeneity, said process comprising the steps of
(a) dispersing nanoparticles in a dispersant to produce a nanoparticles dispersion,
(b) combining the nanoparticles dispersion obtained in step (a) with a thermoplastic polymer composition, and
(c) subsequently removing the dispersant to obtain the nanocomposite.

Alternatively, the present invention provides a process for producing the previously defined nanocomposite having improved homogeneity, said process comprising the steps of
(a) dispersing nanoparticles in a dispersant to produce a nanoparticles dispersion,
(b′) removing either in part or completely the dispersant from the nanoparticles dispersion obtained in step (a) by lyophilization to obtain lyophilized nanoparticles, and
(c′) combining the lyophilized nanoparticles obtained in step (b′) with a thermoplastic polymer composition.

Nanoparticles and thermoplastic polymer composition are as defined above.

The process of the present invention is particularly advantageous as it is simple and does not require additional compounds, such as for example compatibilizers. An example of such a compatibilizer used in combination with nanoparticles are polysaccharides as for example disclosed in patent document WO 2010/012813. Hence, the process for producing the nanocomposite of the present invention is preferably characterized by the absence of compatibilizer. In other words, the preferred process for producing the nanocomposite of the present invention is characterized by making no use of compatibilizers to homogeneously distribute the nanoparticles in the thermoplastic polymer composition.

In the present context, the term “compatibilizer” is used to denote a compound that attaches to the surface of the nanoparticles and thus modifies their surface properties. Compatibilizers in generally are amphiphilic, i.e. different parts of the molecule have different affinities. For example, one part of the compatibilizer may be a polar group, such as for example groups containing carboxyl groups or amines or amides, while another part of the compatibilizer may be a non-polar hydrocarbyl group.

Contrary to all expectations it has been found that the use of compatibilizers is not necessary to achieve a homogeneous dispersion of nanoparticles in a thermoplastic polymer composition as defined above. Surprisingly, the present process for producing a nanocomposite of the present invention has given very good results even for non-polar polymers.

Dispersant

For the present invention it is essential that the nanoparticles are dispersed in a dispersant. It is further essential that said dispersant is polar.

Preferably the dispersant is characterized by a boiling point of at most 150° C. at 1 atm, more preferably of at most 140° C., even more preferably of at most 130° C. or 120° C., still even more preferably of at most 110° C. or 100° C., and most preferably of at most 90° C.

The dispersant is preferably selected from the group consisting of liquid carbon dioxide, water, a liquid polar organic compound or a blend of these. For the purposes of the present invention, a liquid polar organic compound is one that is liquid under standard conditions, i.e. at a temperature of 25° C. and a pressure of 1 atm.

With respect to said liquid polar organic compound, it is preferred that it comprises at least one functional group comprising oxygen or nitrogen or both.

With respect to said liquid polar organic compound, it is more preferred that it comprises at least one of the functional groups selected from the list consisting of ether group (—O—), keto group (—C(═O)—), hydroxyl group (—OH), carboxy group (—C(═O)O—), amino group, amido group (—NH—C(═O)—), and hydroxyl amino group (N—OH).

With respect to said liquid polar organic compound, it is even more preferred that it is selected from the group consisting of ethers (R₁—O—R₂), ketones (R₁—CO—R₂), alcohols (R₁—OH), carboxylic acids (R₁—COOH), carboxylic acid esters (R₁—COO—R₂), amines (NR₁R₂R₃), amides (R₁—NH—CO—R₂), hydroxylamines (R₁R₂N—OH), or a blend of any of these, wherein R₁, R₂ and R₃ are independently selected from one another and are hydrogen, C₁ to C₁₀ alkyls, C₃ to C₁₈ cycloalkyl or C₆ to C₁₈ aryl radicals, with the proviso that the polar organic compound is liquid under standard conditions. R₁, R₂ and R₃ may also contain atoms different from carbon and hydrogen, such as for example halogen atoms, particularly fluorine or chlorine, or oxygen atoms; thus R₁, R₂ and R₃ may for example be halogenated hydrocarbons or alkyl hydroxyl or aryl hydroxyl. Within the above definition of R₁, R₂ and R₃ it is preferred that they are independently selected from one another and are hydrogen; C₁ to C₄ alkyls, such as methyl, ethyl, n-propyl, iso-propyl, n-butyl, iso-butyl or tert-butyl; C₄ to C₆ cycloalkyl, such as cyclobutyl, cyclopentyl or cyclohexyl; or C₆ to C₈ aryl radicals, such as phenyl.

With respect to said liquid polar organic compound, it is still even more preferred that it is selected from the group consisting of ethers (R₁—O—R₂), ketones (R₁—CO—R₂), alcohols (R₁—OH), amines (NR₁R₂R₃), or a blend of any of these, with R₁, R₂ and R₃ defined as above.

With respect to said liquid polar organic compound, it is most preferred that it is selected from the group consisting of ethers (R₁—O—R₂), ketones (R₁—CO—R₂), alcohols (R₁—OH), and blends of these.

Examples of particularly suited ethers are dimethylether, ethylmethylether, diethylether, butylethylether and diisopropylether.

Examples of particularly suited ketones are acetone, 2-butanone (ethylmethylketone), 2-pentanone, 3-pentanone, 2-hexanone, 3-hexanone, 4-hexanone, 2-ocatanone, 3-octanone, 4-octanone and acetophenone. The most preferred ketone is acetone.

Examples of particularly suited alcohols are methanol, ethanol, propanol, isopropanol, 1-butanol, 2-butanol, 2-methyl-1-propanol, 1-pentanol, 2-pentanol, 3-pentanol, 2-methyl-1-butanol, 2-methyl-2-butanol, 3-methyl-1-butanol and 3-methyl-2-butanol. Preferred alcohols are methanol, ethanol, propanol and isopropanol. The most preferred alcohol is methanol.

Examples of particularly suited carboxylic acids are formic acid, acetic acid, propionic acid, butyric acid, 2-methylpropionic acid (isobutyric acid), valeric acid, 2-methylbutyric acid and 3-methylbutyric acid (isovaleric acid).

Examples of particularly suited carboxylic acid esters are methyl, ethyl, propyl and butyl esters of the above mentioned carboxylic acid, such as for example methyl acetate, ethyl acetate, propyl acetate or butyl acetate.

Examples of particularly suited amines are diethylamine, dipropylamine, diisopropylamine, dibutylamine, dipentylamine, dihexylamine, triethylamine, tripropylamine, triisopropylamine, tributylamine, tripentylamine, trihexylamine, diethylmethylamine, dipropylmethylamine, dibutylmethylamine and ethylenediamine.

Examples of particularly suited amides are formamide, acetamide, butyramide, N,N-dimethylformamide, N,N-dimethylformamide, and 2,2-diethoxyacetamide.

Examples of particularly suited hydroxylamines are N,N-diethylhydroxylamine, N,N-dipropylhydroxylamine, N,N-dibutylhydroxylamine and N,N-dipentylhydroxylamine.

Examples of particularly suited compounds comprising two functional groups are ethoxylated amines, such as C_{13/15}—N(CH₂—CH₂—OH)₂ which is commercially available as Atmer 163™.

Of all the listed organic polar compounds suitable as dispersants in the present invention methanol, acetone, dimethylether, ethylmethylether, diethylether and any blend of these are most preferred.

The ratio of nanoparticles to dispersant in step (a) depends upon a number of factors, including the nature of the nanoparticles and of the dispersant, Preferably the nanoparticles are comprised in the dispersant in at least 0.1 wt %, more preferably in at least 0.2 wt %, even more preferably in at least 0.5 wt % and most preferably in at least 1.0 wt %, relative to the weight of the dispersant. While there is no particular upper limit, it is nevertheless preferred that the nanoparticles are comprised in the dispersant in at most 5.0 wt %, more preferably in at most 4.0 wt %, even more preferably in at most 3.0 wt %, and most preferably in at most 2.0 wt %, relative to the weight of the dispersant.

It is preferred that the process of dispersing of the nanoparticles in the dispersant is done by cavitation by means of mechanical waves. Preferably, these mechanical waves are generated using ultrasound. Preferably, the ultrasound frequency is in the range from 16 kHz to 5 MHz. Most preferably, the ultrasound frequency is in the range from 20 kHz to 100 kHz. Preferably, the total ultrasound energy is in the range from 10⁻³ J/g dispersant/g nanoparticles to 10⁶ J/g dispersant/g nanoparticles. Most preferably, the total ultrasound energy is in the range from 10⁻³ J/g dispersant/g nanoparticles to 10⁶ J/g dispersant/g nanoparticles. The total ultrasound energy can either be supplied to the dispersion in one single step or in a series of steps, in which case total ultrasound energy refers to the sum of the ultrasound energies supplied in each step. While any ultrasound equipment can be used in the present invention, it is preferred that it is an ultrasound probe that can be directly introduced into the dispersion. The time for which the dispersion needs to be subjected is dependent upon the performance of the ultrasound equipment used as well as the total weight of the dispersion and can easily be determined from simple laboratory experimentation.

Dispersion

Dispersing the nanoparticles in a dispersant in accordance with the present invention results in a nanoparticles dispersion that is characterized by improved stability as compared to prior art dispersions. For example, a 0.2 mg/ml dispersion of multi-walled carbon nanotubes (diameter of 10-20 nm; length of 5-15 μm) in xylene, said dispersion having been subjected to ultrasonication for 10 min, showed complete deposition of the carbon nanotubes after 25 min (S. Liang et al., Polymer 49 (2008) 4925-4929). By contrast, dispersions obtained in accordance with the present invention could be kept for several hours or even days without complete separation of the carbon nanotubes.

The present invention therefore also provides dispersions of nanoparticles, as defined above, and a dispersant, as defined above.

Preferably, the nanoparticles dispersions of the present invention remain dispersed for at least 2 hours or 4 hours or 6 hours, more preferably for at least 12 hours, even more preferably for at least 24 hours, still even more preferably for at least 2 days, and most preferably for at least 7 days.

By “remain dispersed” it is meant that the nanoparticles have not separated from the dispersant and that at most 20% of the dispersant is present as clear supernatant dispersant.

Step (b)—Combining the Nanoparticles Dispersion with the Thermoplastic Polymer Composition

The process of the present invention further comprises the step of combining the nanoparticles dispersion, obtained in the previous step, with a thermoplastic polymer composition as defined previously in this patent application.

The nanoparticles dispersion and the thermoplastic polymer composition may for example be blended. Preferably, said thermoplastic polymer composition is in solid form, such as for example in form of a powder or in form of granules. Said blending can be done by any method known to the person skilled in the art. For example, the thermoplastic polymer composition and the nanoparticles dispersion can be introduced into a mixer, and then intimately mixed together.

Alternatively, the nanoparticles dispersion and the thermoplastic polymer composition may be combined by spraying the nanoparticles dispersion onto the thermoplastic polymer composition. The spraying can for example be done by placing the thermoplastic polymer composition onto a moving belt, passing underneath a spray nozzle, which applies the nanoparticles dispersion to the thermoplastic polymer composition. Said spraying can be conducted for example at ambient temperature and pressure. However, it is preferred that said spraying be conducted either at reduced pressure or at elevated temperature to facilitate the removal of dispersant. By reduced pressure it is meant that the pressure is lower than ambient pressure, for example 0.9 bar or lower. By elevated temperature it is meant that the temperature is above 30° C., provided that the dispersant does not vaporize directly at the spray nozzle under the respective temperature and pressure conditions so as to avoid clogging of the spray nozzle by the nanoparticles.

Alternatively, the nanoparticles dispersion and the thermoplastic polymer composition may be combined by melt-extrusion, e.g. In an extruder, preferably a twin-screw extruder, with simultaneous removal of at least part of the dispersant by evaporation.

Step (c)—Removal of Dispersant

After completion of the combining step (b), the dispersant is removed so as to obtain the nanocomposite. The removal of dispersant can be accomplished by any means known to the person skilled in the art. For example, the dispersant can be separated from the mixture of nanoparticles and thermoplastic polymer composition by filtration or by evaporating the dispersant. It is preferred that the dispersant is removed by evaporation, possibly under reduced pressure. Alternatively, it is also possible to remove the dispersant by melt processing the nanocomposite, for example in a vented extruder.

Step (b′)—Removal of the Dispersant from the Nanoparticles Dispersion by Lyophilization

Alternatively, the dispersant is removed from the nanoparticles dispersion by lyophilization (or freeze-drying) before said nanoparticles dispersion is blended with the thermoplastic polymer composition. Preferred dispersants that are suited for lyophilization have a melting point in the range from −15° C. to 10° C. (at ambient pressure). In this process, the nanoparticles dispersion is first solidified by cooling. The dispersant is then removed under such temperature and pressure conditions that the temperature remains below the triple point temperature, below which the dispersant sublimes, i.e. from solid state directly goes into gaseous state, to obtain lyophilized nanoparticles. Following the removal of the dispersant the lyophilized nanoparticles can be blended with a thermoplastic polymer composition as defined above.

Step (c′)—Combining the Nanoparticles Dispersion with the Thermoplastic Polymer Composition

The process of the present invention further comprises the step of combining the lyophilized nanoparticles obtained in step (b′) with a thermoplastic polymer composition with a thermoplastic polymer composition as defined previously in this patent application.

The lyophilized nanoparticles and the thermoplastic polymer composition may for example be blended. Preferably, said thermoplastic polymer composition is in solid form, such as for example in form of a powder or in form of granules. Said blending can be done by any method known to the person skilled in the art. For example, the thermoplastic polymer composition and the nanoparticles dispersion can be introduced into a mixer, and then intimately mixed together.

Melt-Processing of the Nanocomposites

Preferably, the nanocomposites obtained after removal of the dispersant, i.e. after step (c) or alternatively after step (c′) are further processed at a temperature above the melt temperature, i.e. they are melt-processed Thus, preferably, the process of the present invention further comprises the step of
(d) processing the nanocomposite obtained in step (c) or (c′) at a temperature above the melt temperature of said nanocomposite.

The melt temperature of the nanocomposite can for example be determined by differential scanning calorimetry (DSC), a method that is well known in polymer chemistry and therefore need not be explained in detail. It is noted that generally the melt temperature of the nanocomposite will be substantially the same as that of the thermoplastic polymer composition.

Said melt-processing step (d) can for example be a pelletization, i.e. the production of pellets by melt-extruding the nanocomposite, or step (d) can be a process selected from the list consisting of fiber extrusion, film extrusion, sheet extrusion, pipe extrusion, blow molding, rotomolding, slush molding, injection molding, injection-stretch blow molding and extrusion-thermoforming. Most preferably, step (d) is a process selected from the group consisting of pelletization, fiber extrusion, film extrusion, sheet extrusion and rotomolding. When such a process involves the use of an extruder, it is preferred that the extruder speed is at most 300 rpm (rounds per minute), more preferably at most 250 rpm, even more preferably at most 200 rpm and most preferably at most 160 rpm.

The nanocomposites of the present invention are characterized by excellent distribution of the nanoparticles in the thermoplastic polymer composition. The degree of distribution of the nanoparticles in the thermoplastic polymer composition can be assessed by a method based on ISO 18553:2002 as explained in more detail in the examples. As part of said method based on ISO 18553:2002 the size of particles dispersed in the thermoplastic polymer composition is determined. A nanoparticle is considered “isolated” if the particle size as determined by the method based on ISO 18553:2002 is at most 5 times, more preferably at most 4 times, even more preferably at most 3 times and most preferably at most 2 times the size of an individual nanoparticle. In this context, for nanotubes and nanofibers the “size of an individual nanoparticle” is the maximum outer diameter of said nanotubes and nanofibers. For carbon black, the “size of an individual nanoparticle” is given by the average particle diameter of the carbon black.

The improved distribution of the nanoparticles in the nanocomposites of the present invention can also be shown by transmission electron microscopy (TEM), which allows visualization of isolated nanoparticles, as explained in more detail in the examples.

The nanocomposites of the present invention can be used to produce formed articles. Hence, the present invention also provides articles comprising the nanocomposite of the present invention. Preferred articles are fibers, films, sheets, containers, pipes, foams, rotomolded articles and injection molded articles. Most preferred articles are fibers.

The present inventors have been very surprised by the good processability, particularly in fiber spinning, of the nanocomposites of the present invention. Without wishing to be bound by theory it is believed that the good processability of the nanocomposites of the present invention is attributable to their good homogeneity, which renders them particularly suitable for melt-processing. The advantages of the present nanocomposites are particularly evident in the production of fine fibers, which has either been possible with great difficulties only or not been possible at all with prior art methods, because the presence of nanoparticle agglomerates led to frequent fiber breaks in the melt extrusion of the prior art nanocomposites.

It has also come as a complete surprise that the homogeneity of the nanocomposite can be improved by using a polar solvent even for non-polar thermoplastic polymer compositions, when in fact it seemed rather that a non-polar dispersant would be better suited as it is miscible with non-polar thermoplastics and thus more likely to inhibit or reduce the formation of nanoparticle agglomerates. Without wishing to be bound by theory the present surprising results indicate that it is rather the initial dispersion of the nanoparticles in the dispersant than the step of combining the nanoparticles dispersion with the thermoplastic polymer composition that determines the homogeneity of the final nanocomposite.

### EXAMPLES

The advantages of the present invention are illustrated by the following examples.

### Test Methods

Fiber tenacity and elongation were measured on a Lenzing Vibrodyn according to standard ISO 5079:1995 with a testing speed of 10 mm/min.

Fiber titers were measured on a Zweigle vibrascope S151/2 in accordance with standard ISO 1973:1995.

Distribution of nanoparticles in thermoplastic polymer was determined based on standard ISO 18553:2002 on six injection-molded samples having an average thickness of 15 μm. Depending upon the type of sample, the thickness can be reduced in order to allow light to be transmitted through the sample. So as to allow using the grading system of the ISO 18553 the particle sizes were taken as one fourth of their actual sizes.

### Determination of Nanoparticles Distribution by Transmission Electron Microscopy (TEM):

Injection-molded nanocomposite samples were prepared under standard conditions. From these injection-molded nanocomposite samples microtome slices having an average thickness of 130 nm were cut under cryogenic conditions. An area of ca. 1 mm by 1 mm was then checked optically for the presence of any agglomerated nanoparticles.

### Products

All examples were conducted with multi-walled carbon nanotubes having an apparent density of 50-150 kg/m³, a mean agglomerate size of 200-500 μm, a carbon content of more than 90 wt %, a mean number of 5-15 walls, an outer mean diameter of 10-15 nm and a length of 0.1-10 μm.

For Examples 1 to 4 and Comparative Examples 1 and 2 a fluff of a propylene homopolymer having a melt flow index of 25 dg/min, measured according to ISO 1133, condition L, at 230° C. and 2.16 kg, commercially available from TOTAL PETROCHEMICALS as MR2001 was used as thermoplastic polymer composition. MR2001 is characterized by a narrow molecular weight distribution (M_{w}/Mₙ) of less than 3. It is particularly suited for fiber applications.

For Example 5 a thermoplastic polylactic acid) having a melt index in the range from 15 to 30 dg/min (ASTM D 1238, at 210° C.), a crystalline melt temperature of 160-170° C. (ASTM D 3418) and a glass transition temperature of 55-60° C. (ASTM D 3417), was used as thermoplastic polymer composition, commercially available from NatureWorks LLC.

### Preparation of the Nanocomposites

### Example 1

1.5 g of the above multi-walled carbon nanotubes were added to 165 ml of Atmer 163 as dispersant in a 400 ml container, thereby forming a nanotube/dispersant mixture. The mixture was sonificated for 2700 s and a total energy of 1300 J/g dispersant/g nanoparticles using a Sonics VCX 400 model to obtain a dispersion of nanotubes in dispersant. This dispersion was then diluted with 100 ml of acetone, blended with 1500 g of the above described fluff of a propylene homopolymer, and finally dried at 70° C. for 24 hours in an oven under constant nitrogen flow. The so-obtained nanocomposite of nanotubes and propylene homopolymer was a free-flowing powder with about 0.1 wt % of carbon nanotubes with respect to the total weight of the nanocomposite.

The so-obtained nanocomposite was then melt-extruded into pellets (“nanocomposite pellets”) at a melt temperature of 190° C., a throughput of 4.5 kg/h and a screw speed of 80 rpm using a Brabender twin-screw extruder having a screw with a diameter of 19 mm and a length to diameter ratio of 40.

### Example 2

12.68 g of the above multi-walled carbon nanotubes were added to 2000 ml of acetone as dispersant, thereby forming a nanotube/dispersant mixture. The mixture was sonificated in four steps for a total of 5100 s and a total energy of 122 J/g dispersant/g nanoparticles using a Vibra cell 75043 to obtain a dispersion of nanotubes in dispersant. This dispersion was then blended with 2500 g of the above described fluff of a propylene homopolymer, and dried at 70° C. for 24 hours in an oven under constant nitrogen flow. The so-obtained nanocomposite of nanotubes and propylene homopolymer was a free-flowing powder with about 0.5 wt % carbon nanotubes with respect to the total weight of the nanocomposite.

The so-obtained nanocomposite was then melt-extruded into pellets (“nanocomposite pellets”) at a melt temperature of 204° C., a throughput of 2 kg/h and a screw speed of 100 rpm on a Leistritz ZSE18HPE twin screw extruder with a screw diameter of 18 mm and a length to diameter ratio of 40.

### Example 3

25 g of the above multi-walled carbon nanotubes were added to 2000 ml of acetone as dispersant, thereby forming a nanotube/dispersant mixture. The mixture was sonificated in three steps for a total of 3800 s and a total energy of 48 J/g dispersant/g nanoparticles using a Vibra cell 75043 to obtain a dispersion of nanotubes in dispersant. This dispersion was then blended with 2500 g of the above described fluff of a propylene homopolymer, and dried at 70° C. for 24 hours in an oven under constant nitrogen flow. The so-obtained nanocomposite of nanotubes and propylene homopolymer was a free-flowing powder with about 1 wt % carbon nanotubes with respect to the total weight of the nanocomposite.

The so-obtained nanocomposite was then melt-extruded into pellets (“nanocomposite pellets”) at a melt temperature of 206° C., a throughput of 2.5 kg/h and a screw speed of 100 rpm on a Leistritz ZSE18HPE twin screw extruder with a screw diameter of 18 mm and a length to diameter ratio of 40.

### Example 4

50 g of the above multi-walled carbon nanotubes were added to 2000 ml of acetone as dispersant, thereby forming a nanotube/dispersant mixture. The mixture was sonificated in two steps for a total of 2300 s and a total energy of 14 μg dispersant/g nanoparticles using a Vibra cell 75043 to obtain a dispersion of nanotubes in dispersant. This dispersion was then blended with 2500 g of the above described fluff of a propylene homopolymer, and dried at 70° C. for 24 hours in an oven under constant nitrogen flow. The so-obtained nanocomposite of nanotubes and propylene homopolymer was a free-flowing powder with about 2 wt % carbon nanotubes with respect to the total weight of the nanocomposite.

The so-obtained nanocomposite was then melt-extruded into pellets (“nanocomposite pellets”) at a melt temperature of 207° C., a throughput of 2 kg/h and a screw speed of 100 rpm on a Leistritz ZSE18HPE twin screw extruder with a screw diameter of 18 mm and a length to diameter ratio of 40.

### Comparative Example 1 (CE-1)

2500 g of the above described fluff of a propylene homopolymer were melt-extruded into pellets at a melt temperature of 210° C., a throughput of 2 kg/h and a screw speed of 100 rpm on a Leistritz ZSE18HPE twin screw extruder with a screw diameter of 18 mm and a length to diameter ratio of 40.

### Comparative Example 2 (CE-2)

13.0 g of the above multi-walled carbon nanotubes were blended with 1300 g of the above described fluff of a propylene homopolymer, and then melt-extruded into pellets (“nanocomposite pellets”) at a melt temperature of 208° C., a throughput of 2.1 kg/h and a screw speed of 100 rpm on a Leistritz ZSE18HPE twin screw extruder with a screw diameter of 18 mm and a length to diameter ratio of 40. The so-obtained nanocomposite pellets had about 1 wt % of carbon nanotubes with respect to the total weight of the nanocomposite.

### Example 5

4 g of the above multi-walled carbon nanotubes were added to 800 ml of acetone as dispersant, thereby forming a nanotube/dispersant mixture. The mixture was sonificated in seven steps for a total of 6900 s and a total energy of 869 J/g dispersant/g nanoparticles using a Vibra cell 75043 to obtain a dispersion of nanotubes in dispersant. This dispersion was then blended with 2000 g of the above thermoplastic poly(lactic acid), and dried at 70° C. for 24 hours in an oven under constant nitrogen flow. The so-obtained nanocomposite of nanotubes and propylene homopolymer was a free-flowing powder with about 2 wt % carbon nanotubes with respect to the total weight of the nanocomposite.

The so-obtained nanocomposite was then melt-extruded into pellets (“nanocomposite pellets”) at a melt temperature of 189° C., a throughput of 2.5 kg/h and a screw speed of 110 rpm on a Leistritz ZSE18HPE twin screw extruder with a screw diameter of 18 mm and a length to diameter ratio of 40.

The PLA/nanotube composite was characterized by very good homogeneity. It can therefore be expected that the processability of the PLA/nanotube composite is comparable to that of pure PLA.

### Fiber Spinning

The nanocomposite pellets of examples 1 to 4 and of comparative examples 1 and 2 were spun into fibers on a laboratory fiber spinning line by Plasticisers. The nanocomposites are molten in a single screw extruder to a melt temperature Tₘₑₗₜ, passed through a melt pump ensuring a constant feeding rate and then extruded through a single die having 40 or 120 holes, each hole having a diameter of 0.5 mm, under constant throughput, thus obtaining molten filaments. The still molten filaments are cooled using air at ambient temperature to form solid filaments, which are then run over two sets of rolls. The first set of these (roll set 1) comprises two roll stacks of three rolls each, and a second set of rolls (roll set 2) comprises one roll stack of three rolls. The first roll of roll set 1 may be heated to a temperature T₁₋₁, the second roll of roll set 1 may be heated to a temperature T₁₋₂. Roll speeds are V₁ for the first set of roils and V₂ for the second set of rolls.

With the nanocomposites of examples 1 to 4 and the composition of comparative examples 1 different fibers were produced. Fiber spinning conditions are given in table 1, fiber properties in table 2. Fiber spinning proved much more difficult with the composition of comparative example 2 due to a high number of fiber breaks.

TABLE 1

| | | | | | | | | Stretching |
|---|---|---|---|---|---|---|---|---|
| | Tₘₑₗₜ | Throughput | Number | T₁₋₁ | T₁₋₂ | V₁ | V₂ | ratio |
| Ex. | ° C. | g/h | of holes | ° C. | ° C. | m/min | m/min | V₂/V₁ |
| 1-A | 210 | 360 | 40 | 45 | 55 | n.a.¹ | 200 | 1 |
| 1-B | 210 | 360 | 40 | 45 | 55 | 100 | 200 | 2 |
| 1-C | 210 | 360 | 40 | 45 | 55 | 50 | 200 | 4 |
| 2 | 210 | 814 | 120 | 90 | 95 | 40 | 200 | 5 |
| 3 | 210 | 651 | 120 | 90 | 95 | 15 | 105 | 7 |
| 4 | 221 | 651 | 120 | 90 | 95 | 15 | 100 | 6.67 |
| CE-1 | 210 | 360 | 40 | 45 | 55 | n.a.¹ | 200 | 1 |

¹The first set of rolls of the fiber spinning line were by-passed.

The present inventors have been very surprised by the good processability of the nanocomposites prepared in accordance with the present invention in fiber spinning. Due to the fact that fibers are very thin, distribution of the nanoparticles in the thermoplastic polymer composition is very critical in fiber spinning because agglomerates of nanoparticles will result in fiber breaks. The present examples and their good processing in fiber spinning can therefore be interpreted as sign of good homogeneity of the nanocomposite, as compared to comparative example CE-2 prepared by simple melt-blending of the nanoparticles in the thermoplastic polymer.

TABLE 2

| | Fiber | Fiber | Fiber strength | Elongation |
|---|---|---|---|---|
| | titer | diameter | @ max. | at break |
| Ex. | dtex | μm | mN | % |
| 1-A | 6.05 | 29.2 | 90 | 208 |
| 1-B | 5.85 | 28.7 | 130 | 101 |
| 1-C | 7.10 | 31.6 | 190 | 62 |
| CE-1 | 5.25 | 21.2 | 80 | 223 |

Furthermore, the good distribution of the nanotubes in the polypropylene is indirectly confirmed by the fact that the properties of the fibers of example 1-A and the fibers of comparative example CE-1, which does not contain any nanotubes, are very close in elongation at break as nanotube agglomerates would create starting points for breaks, thus leading to a marked reduction in fiber elongation. This is further confirmed by the properties of the higher-drawn fibers. Due to the higher stress in stretching fibers with nanotube agglomerates would tend to break even more easily. It has therefore been very surprising that no difference in breaks were observed for the nanocomposite fibers as compared to the polypropylene fibers of the comparative example.

### Characterization of Nanoparticles Distribution

Nanoparticles distribution was determined on
(i) nanocomposite pellets prepared according to example 1 (Atmer 163 as dispersant) but having about 1 wt % carbon nanotubes, in the following referred to as example 6;
(ii) the nanocomposite pellets of example 3 (acetone as dispersant);
(iii) nanocomposite pellets prepared according to comparative example 2 but about 3 wt % carbon nanotubes, in the following referred to as comparative example 3 (CE-3)
   using the previously described method based on ISO 18553:2002. Results are given in Table 3 for example 6, in Table 4 for example 3, and in Table 5 for comparative example 3.

TABLE 3

| | Sam- | Sam- | | | | |
|---|---|---|---|---|---|---|
| Size [μm] | ple 1 | ple 2 | Sample 3 | Sample 4 | Sample 5 | Sample 6 |
| 5-10* | 4 | 6 | 2 | 3 | 6 | 3 |
| 10-20* | 1 | 0 | 2 | 1 | 3 | 1 |
| 20-30* | 0 | 0 | 0 | 0 | 0 | 0 |
| 30-40* | 0 | 0 | 0 | 0 | 0 | 0 |
| 40-50* | 0 | 0 | 0 | 0 | 0 | 0 |
| 50-60* | 0 | 0 | 0 | 0 | 0 | 0 |
| 60-70* | 0 | 0 | 0 | 0 | 0 | 0 |
| 70-80* | 0 | 0 | 0 | 0 | 0 | 0 |
| 80-90* | 0 | 0 | 0 | 0 | 0 | 0 |
| 90-100* | 0 | 0 | 0 | 0 | 0 | 0 |
| 100-110* | 0 | 0 | 0 | 0 | 0 | 0 |
| 110-120* | 0 | 0 | 0 | 0 | 0 | 0 |
| 120-130* | 0 | 0 | 0 | 0 | 0 | 0 |
| >140* | 0 | 0 | 0 | 0 | 0 | 0 |
| Grade | 1.5 | 1.5 | 1.5 | 1 | 1.5 | 1 |

*In order to obtain the actual size the indicated values need to be multiplied by a factor of 4.

TABLE 4

| | Sam- | Sam- | | | | |
|---|---|---|---|---|---|---|
| Size [μm] | ple 1 | ple 2 | Sample 3 | Sample 4 | Sample 5 | Sample 6 |
| 5-10* | 3 | 5 | 5 | 1 | 7 | 5 |
| 10-20* | 3 | 0 | 1 | 3 | 1 | 1 |
| 20-30* | 0 | 0 | 0 | 0 | 0 | 0 |
| 30-40* | 0 | 0 | 0 | 0 | 0 | 0 |
| 40-50* | 0 | 0 | 0 | 0 | 0 | 0 |
| 50-60* | 0 | 0 | 0 | 0 | 0 | 0 |
| 60-70* | 0 | 0 | 0 | 0 | 0 | 0 |
| 70-80* | 0 | 0 | 0 | 0 | 0 | 0 |
| 80-90* | 0 | 0 | 0 | 0 | 0 | 0 |
| 90-100* | 0 | 0 | 0 | 0 | 0 | 0 |
| 100-110* | 0 | 0 | 0 | 0 | 0 | 0 |
| 110-120* | 0 | 0 | 0 | 0 | 0 | 0 |
| 120-130* | 0 | 0 | 0 | 0 | 0 | 0 |
| >140* | 0 | 0 | 0 | 0 | 0 | 0 |
| Grade | 1.5 | 1.5 | 1.5 | 1.5 | 2 | 1.5 |

*In order to obtain the actual size the indicated values need to be multiplied by a factor of 4.

TABLE 5

| | Sam- | Sam- | Sam- | | | |
|---|---|---|---|---|---|---|
| Size [μm] | ple 1 | ple 2 | ple 3 | Sample 4 | Sample 5 | Sample 6 |
| 5-10* | >12 | >12 | >12 | >12 | >12 | >12 |
| 10-20* | >12 | >12 | >12 | >12 | >12 | >12 |
| 20-30* | >1 | >5 | >6 | >8 | >6 | >12 |
| 30-40* | >2 | >2 | >8 | >9 | >2 | >9 |
| 40-50* | >2 | >4 | >8 | >11 | >3 | >8 |
| 50-60* | >6 | >6 | >5 | >3 | >2 | >3 |
| 60-70* | 2 | 5 | 4 | 5 | 2 | 2 |
| 70-80* | 1 | 1 | 0 | 2 | 2 | 2 |
| 80-90* | 2 | 1 | 0 | 1 | 1 | 0 |
| 90-100* | 0 | 0 | 2 | 2 | 1 | 1 |
| 100-110* | 0 | 1 | 0 | 3 | 0 | 0 |
| 110-120* | 0 | 1 | 0 | 1 | 1 | 0 |
| 120-130* | 0 | 0 | 0 | 0 | 0 | 1 |
| >140* | “164” | “148” | 0 | “193” | “136/132/171” | “134/210” |
| Grade | 8.5 | 7.5 | 5.5 | 10 | 9 | 10 |

*In order to obtain the actual size the indicated values need to be multiplied by a factor of 4.

The results clearly show that the nanocomposites of the present invention, wherein the nanoparticles are dispersed in a dispersant prior to their blending with a thermoplastic polymer, show much improved homogeneity when compared to the comparative example wherein the nanoparticles are directly blended with the thermoplastic polymer without their prior dispersion in a dispersant.

1. Nanocomposite comprising a thermoplastic polymer composition and at least 0.001% by weight, relative to the total weight of nanocomposite, of nanoparticles, characterized in that isolated nanoparticles are present, as assessed by a method based on ISO 18553:2002.

2. Nanocomposite according to claim 1, wherein at least 1.0% by weight of the nanoparticles, relative to the total weight of nanoparticles, is present as isolated nanoparticles.

3. Nanocomposite according to claim 1, wherein the nanoparticles are selected from the group consisting of nanotubes, nanofibers, carbon black and blends of these.

4. Nanocomposite according to claim 1, wherein the nanoparticles are carbon nanotubes, preferably multi-walled carbon nanotubes, more preferably multi-walled carbon nanotubes having on average from 5 to 15 walls.

5. Nanocomposite according to claim 4, wherein the multi-walled carbon nanotubes have an average outer diameter in the range from 10 nm to 20 nm or an average length in the range from 100 nm to 10 pm or both.

6. Nanocomposite according to claim 1, wherein the thermoplastic polymer composition comprises at least 50% by weight, relative to the total weight of the thermoplastic polymer composition, of a polymer selected from the group consisting of polyolefins, polyamides, polyester, polylactic acid (PLA), polystyrenes or blends of these.

7. Formed articles comprising the nanocomposite of claim 1.

8. Process for producing the nanocomposite of claim 1 having improved homogeneity, said process comprising the steps of
(a) dispersing nanoparticles in a dispersant to produce a nanoparticles dispersion,
(b) combining the nanoparticles dispersion obtained in step (a) with a thermoplastic polymer composition, and
(c) subsequently removing the dispersant to obtain the nanocomposite, wherein the dispersant is polar.

9. Process for producing the nanocomposite of claim 1 having improved homogeneity, said process comprising the steps of
(a) dispersing nanoparticles in a dispersant to produce a nanoparticles dispersion,
(b′) removing either in part or completely the dispersant from the nanoparticles dispersion obtained in step (a) by lyophilization to obtain lyophilized nanoparticles, and
(c′) combining the lyophilized nanoparticles obtained in step (b′) with a thermoplastic polymer composition,
wherein the dispersant is polar.

10. Process according to claim 8, wherein the dispersant is characterized by a boiling point of at most 150° C. at 1 atm.

11. Process according to claim 8, wherein the dispersant is selected from the group consisting of liquid carbon dioxide, water, or a liquid polar organic compound or a blend of these, wherein the liquid polar organic compound is one that is liquid under standard conditions, i.e. at a temperature of 25° C. and a pressure of 1 atm.

12. Process according to claim 8, wherein step (a) further comprises dispersing the nanoparticles in the dispersant by using ultrasound.

13. Process according to claim 8, further defined according to any of claims 3 to 6.

14. Dispersion comprising nanoparticles and a dispersant, wherein the dispersant is selected from the group consisting of liquid carbon dioxide, water, a liquid polar organic compound or a blend of these, wherein the liquid polar organic compound is one that is liquid under standard conditions, i.e. at a temperature of 25° C. and a pressure of 1 atm.

15. Dispersion according to claim 14, characterized in that the nanoparticles remain dispersed for at least 2 hours.
